(19) United States
(12) Patent Application Publication
(10) Pub. No.: US 2016/0074868 A1
(43) Pub. Date: Mar. 17, 2016

(54) GRINDING METHOD AND DEVICE

(71) Applicant: Lev Konstantinovich BOGDANOV, Saint-Petersburg (RU)

(72) Inventor: Lev Konstantinovich BOGDANOV, Saint-Petersburg (RU)

(21) Appl. No.: 14/440,080

(22) PCT Filed: Apr. 22, 2014
(86) PCT No.: PCT/RU2014/000295

§ 371 Date: Nov. 27, 2015

(30) Foreign Application Priority Data
Feb. 26, 2013 (RU) 2013108795

(51) Int. Cl. B02C 15/12

(52) U.S. Cl. CPC B02C 15/12

(57) ABSTRACT

The present invention relates to processes for disintegrating brittle materials using mechanical devices. The present invention can be used in all fields of industry where it is necessary to produce powders having a particle size ranging from several millimeters to nano-sizes. FIG. 1 illustrates the essence of the proposed grinding method. Grinding bodies (1) are situated in a single layer between two support surfaces (2). The gap between the grinding bodies (1) and the support surfaces is established and regulated to be less than 0.86 of the diameter of the grinding body (1), thus automatically maintaining the grinding bodies (1) in a single layer. Particles of starting material (3) are fed onto one of the support surfaces (2) which is displaced relative to the grinding body (1) and to which rotational motion is imparted by means of friction with said support surface (2). The particles of the starting material (3), because their size is 15-20 times smaller than the diameter of the grinding body, (the capture angle of the particles of starting material (3) by the grinding body (1) is smaller than the angle of friction of the material of the particles of starting material (3) against the material of the grinding bodies (1)), are pulled under the the grinding body (1) and, because the vertical displacement of the grinding body (1) is limited by the second support surface (2), the particles of starting material (3) are thus crushed by the grinding bodies (1).

### TECHNICAL FIELD

The present invention relates to a process of disintegration of mechanically fragile materials. It can be used in all industries where it is necessary to obtain powders in the size range from a few millimeters to the nano size.

The proposed method and its implementing device is mechanical destruction by abrasion and crushing of particles of the starting material with grinding bodies on the supporting surface and the interaction between the grinding bodies themselves.

### BACKGROUND OF THE INVENTION

There are ways to implement such destruction balls or rods in drum mills (see. Sidenko P M grinding in the chemical industry, ed. 2nd rev., Moscow, Chemistry, 1977), balls—in a vibrating mill, planetary mills, attritor (see. Sidenko P M grinding in the chemical industry. Ed. 2nd rev., Moscow, Chemistry, 1977; Andreev S E, Perov V A Zverevich crushing, grinding and screening of minerals. M., Nedra, 1980), the balls—in a bead mill (see. Sidenko P M grinding in the chemical industry, ed. 2nd rev., Moscow, Chemistry, 1977). For all its merits all these devices suffer from two major drawbacks: The high cost of energy at idle, and as a consequence; low efficiency; Restriction of blunt force a mass of milling bodies and give them accelerated, which significantly reduces the efficiency of the process with decreasing size of the crushed material and increase the requirements for fineness.

The closest to the proposed method of grinding on the principle underlying the interaction between the particles of the starting material and its destructive elements, a process to grind, founded in runners (see. Sidenko P M grinding in the chemical industry, ed. 2nd rev. M., Chemistry, 1977).

In the grinding material particles are crushed and ground between the grinding media and the support surface. While some of these elements has the shape of a body of revolution (grindstone), and the other—to create a closed support surface (bowl), and rotated.

Although repeatedly aimed a devastating effect on the material and makes it possible to obtain a product in such a way fine, it fully possess all the deficiencies noted above.

### SUMMARY OF THE INVENTION

In the method of grinding by the fact that the grinding bodies arranged between the two support surfaces breaking force which is transmitted to the particle through the grinding bodies from one or both reference planes, is not dependent on the mass of the milling body and is determined only by the power drive, which is moved by reference plane.

This no-load losses due to the balance of the rotating masses are determined only by rolling friction losses generated by grinding as it moves through the supporting surface.

This allows increasing the power density of the process to the extent necessary, with an efficiency of up to 90% of direct force applied directly to the disintegration of the starting material, whereby a high efficiency to obtain finished products of virtually any fineness down to nano sizes.

The proposed method has significant advantages in comparison with the prototype and izvestnmi ways in which the grinding media move most of the energy consumed is depending on the presence or absence with the crushed material.

From the prior art proposed method, except the previously noted features, characterized by having a large number of milling bodies of various properties, shapes and forms in combination with the same variety of types of support surfaces and the widest variety of configurations and methods of mutual arrangement of all these elements.

The devices implementing the inventive method of grinding, the goal—increasing process efficiency is achieved due to the fact that the stationary housing concentrically placed with them from rotating drive rotor and the gap between them has grinding bodies; wherein the shape and configuration of these elements is carried out in various combinations and embodiments and to increase the productivity of such devices are inserted concentrically into one another.

### BRIEF DESCRIPTION OF THE DRAWINGS

FIG. 1 illustrates the principle of interaction of grinding bodies and support surfaces with the particles of the crushed material.

FIG. 2 illustrates variant ordered arrangement of milling tools for horizontal support surface.

FIG. 3 illustrates option spontaneous placement of grinding bodies.

FIG. 4 illustrates variant ordered arrangement of grinding bodies on the vertically arranged parallel to the supporting surface.

FIG. 5 illustrates option spontaneous placement of grinding bodies on inclined surfaces arranged parallel support.

FIG. 6 illustrates option spontaneous placement of grinding bodies in the support plane at an angle to each other.

FIG. 7 illustrates cross-section of a single-layer device.

FIG. 8 illustrates a cross section of a multilayer device.

### BRIEF DESCRIPTION OF THE INVENTION

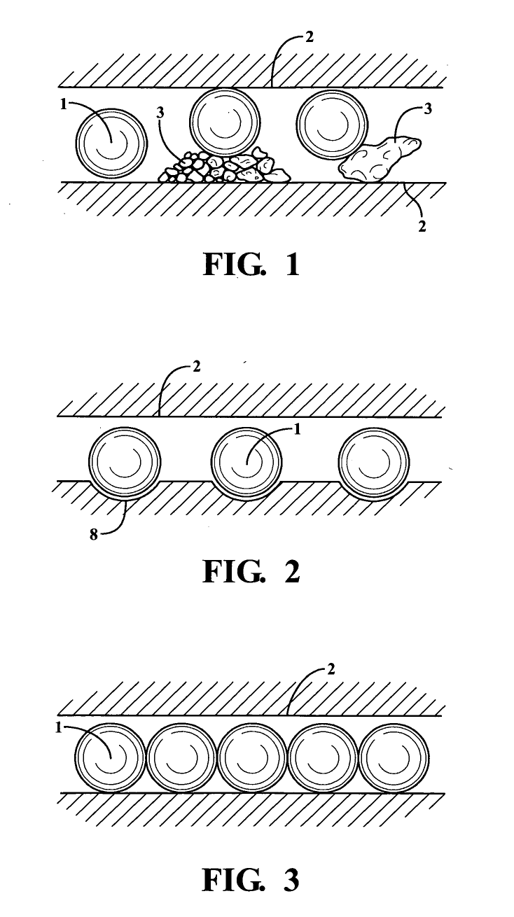

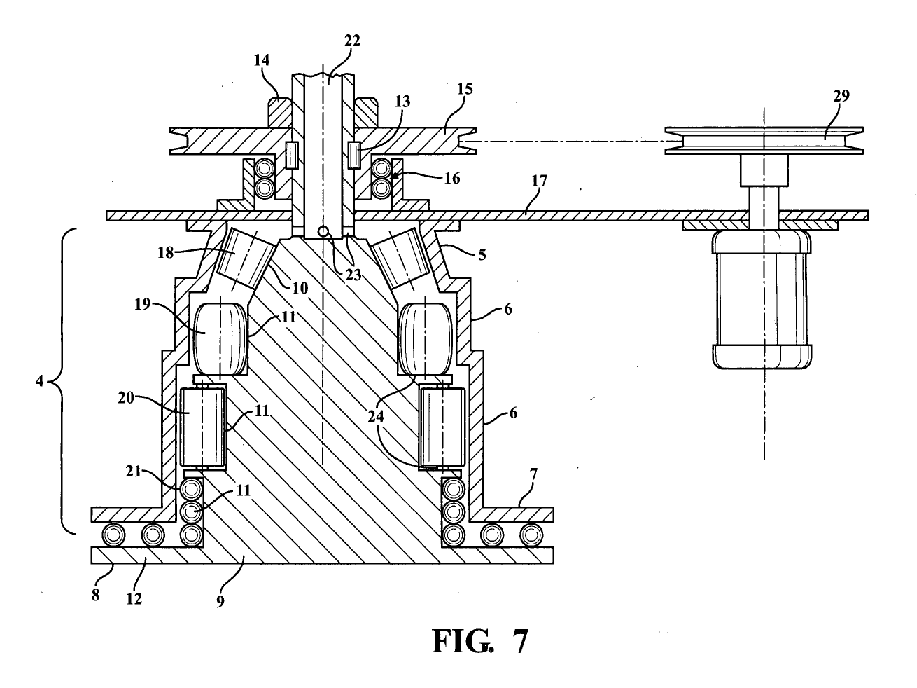

FIG. 1 illustrates the essence of the process of grinding. Grinding bodies 1 arranged in a single layer between the two support surfaces 2. In this case, the gap between the grinding bodies 1 and 2 bearing surfaces are regulated in the range less than 0.86 of the diameter of the grinding body 1 than a single layer is maintained automatically placing the grinding bodies 1. The particles of the starting material 3 is supplied to one of two bearing surfaces which are moved relative to the grinding bodies 1 and that by the friction with this support surface 2 a rotational movement. The particles of the starting material 3 due to the fact that their dimensions in the 15-20 times smaller than the diameter of the grinding body 1 (the angle of capture of particles of the starting material 3 the grinding body 1 with less than the angle of friction material particles of the starting material 3 of grinding media material 1), tightened by grinding body 1, and because the second support surface 2 restrict the possibility of vertical movement of the grinding bodies 1, the thus produced particle crushing starting material 3 grinding bodies 1. In this grinding bodies 1 shaped as bodies of revolution and the support surfaces 2—configuration, for which grinding bodies 1 move along a closed path. The bearing surfaces perform: 5,10 conical, cylindrical, 6.11, 7.12 flat configuration (FIG. 7). Form 1 attach grinding bodies: spherical 21, 20 cylindrical, conical 18, barrel 19, or any other, shaped bodies of rotation (7).

Depending on the requirements of the process of grinding the supporting surfaces 2 or rotated toward each other, or both—in the same direction but at different speeds, or move only one of them. To improve the efficiency of grinding depending on the maximum particle size of the crushed material and changes its properties during disintegration supporting surfaces 2 while moving the grinding material to be unloaded on the load operate the various configurations, sizes and attached thereto various compression forces; place them concentrically or eccentrically and grinding bodies 1, which is placed in the gap between them, give different: size, shape, type of cuts and load them in different amounts, and the gap is adjusted continuously or stepwise.

This grinding bodies 1 arranged orderly (FIG. 2,4) or spontaneously (FIG. 3,5,6). The orderly arrangement of grinding bodies 1 regulate, for example, due to the fact that they are placed in the guide grooves 8 (FIG. 2,4,7). To accommodate spontaneous grinding bodies 1 between the bearing surfaces 2 uses gravity.

Due to the fact that the change in the ratio between the number of spontaneous and orderly placed grinding bodies 1 alter the relationship between the crushing and abrading forces during grinding—the more grinding bodies arranged spontaneously, the more produce grinding abrasion, and the more grinding bodies arranged in an orderly, the more be ground material is subjected to crushing.

The process efficiency is increased by comminution that grinding bodies and the bearing surfaces is provided with notches of various shapes and configurations. Notches fulfill ring, screw, continuous or discontinuous with the profile of the teeth: a triangular, trapezoidal or spherical. Profile incisions can be made with any other configuration.

Depending on changes in the properties of the starting material 3 as reducing its size during grinding smoothly or stepwise change the shape, size, number and type of cuts, the number of grinding bodies 1 are also configured to form incisions and the speed of rotation supporting surfaces 2, as well as the gap width between grinding bodies 1 and 2 bearing surfaces.

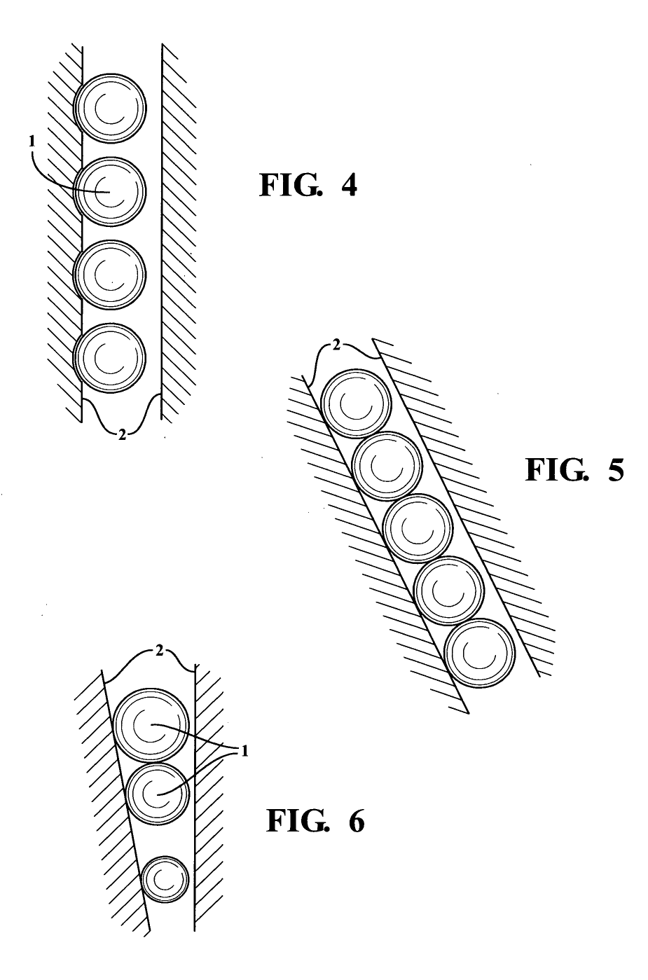

When the vertical position or silnonaklonnom two abutment surfaces (FIG. 4,5) 3 the ground material is moved, usually under the influence of gravity.

In embodiments, horizontal or sloping arrangement of supporting surfaces 2 and, when this movement prevents centrifugal force pressing the material to be ground 3 to the movable support surface 2 using either a mechanical way to move, which on a stationary support surface 2 is fixed inclined plane (augers) or the starting material to a liquid or gaseous flow medium which is pumped force between the contact surfaces in the direction of loading of the grinding material 3 to the place of unloading. The efficiency of crushing and impact due to the fact that the direction of change and controlling the flow rate of liquid or gaseous media.

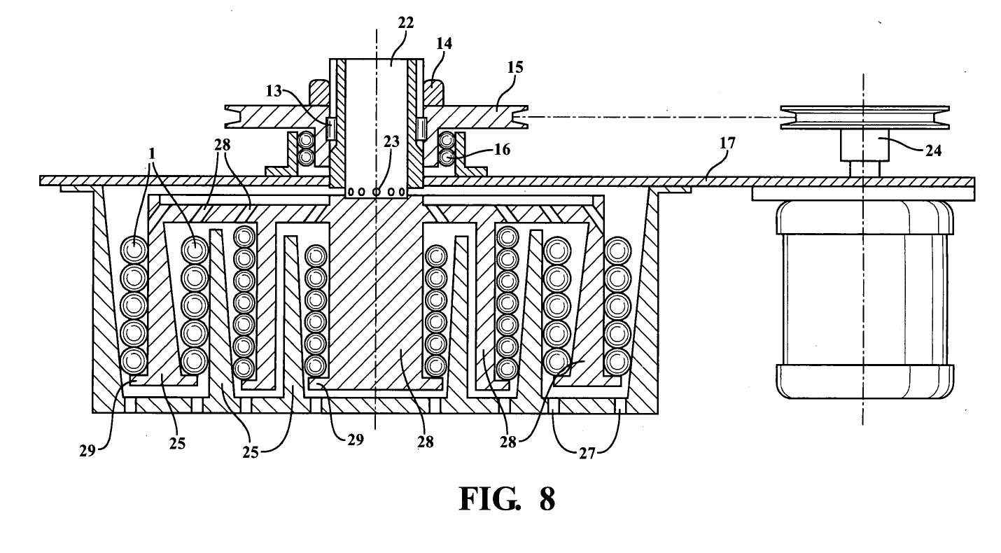

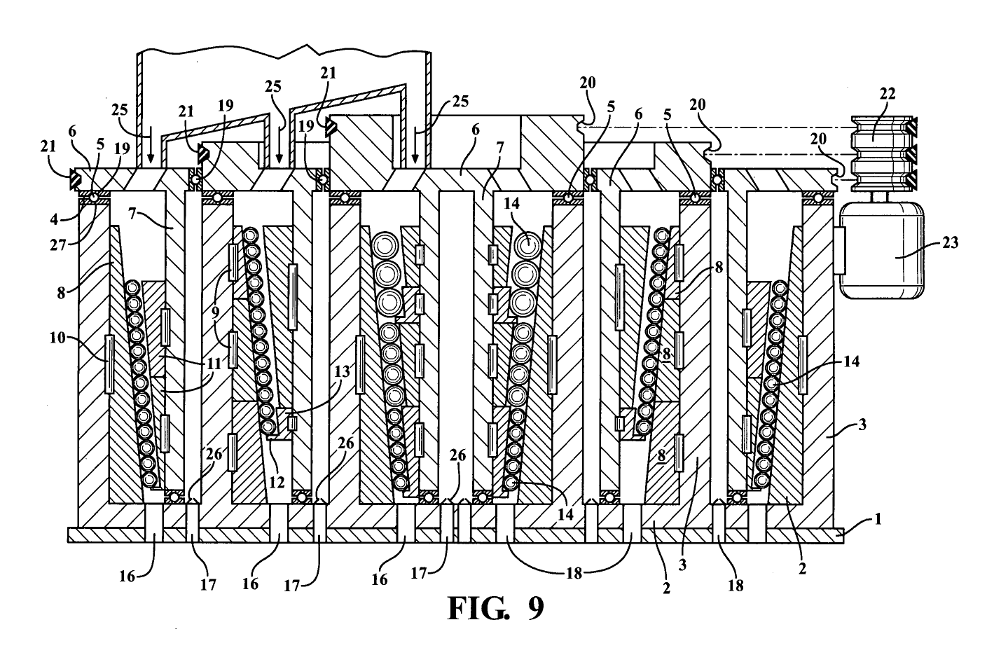

FIGS. 7 and 8 illustrate embodiments of practical realization of the method in devices for grinding. In the embodiment, a single-layer device for grinding (FIG. 7) it consists of fixedly connected to the common case 4: 5 of the conical part of the housing, the cylindrical housing stepped portion 6 consisting of a hollow cylinder or different diameters and body horizontal portion 7 having a circular shape. In the inside of the housing 4 is inserted into the rotor with a gap 9, formed of fixedly interconnected: the conical portion of the rotor 10, a cylindrical stepped portion of the rotor 11 consisting of one or several cylinders with different diameters, and the horizontal portion of the rotor 12 having the shape of a circle concentric with Rout 8 grooves.

In the rotor 9 in its upper part is made with an internal sample 22 drilled in the walls of the lower part feed path 23. When the rotor 9 through the key 13 and sliding through the adjusting nut 14 is fixed to the driven pulley 15 rotating in the rotation support 16, which, like body 4 and drive 24 fixed to the base 17. The gap between the housing and the rotor is filled with grinding bodies 1 of different size, shape. These are: tapered rollers 18, cylindrical rollers 20, barrel-shaped rollers 19 and 21 balls.

In a change in the shape or diameter of the rotor 9 fastened thereto restrictive washers 29.

Submitted device 7 combines several variants. In principle, it can only be conical and cylindro-conical, horizontal, and any other combination of connections between a rotor body of various shapes and sizes.

In an embodiment of a multilayer device 8 for grinding of body 4 consists of various progressively decreasing diameter disposed concentrically in each other and rigidly interconnected concentric parts of the housing 25, drilled in the bottom of the housing 4 unloading openings 27.

The rotor 9 is composed of various progressively decreasing diameter disposed concentrically in each other and interconnected concentric portions of the rotor 26 in the upper connecting flange which is inclined from the center to the periphery drilled feed hole 28. In the lower parts of the concentric portions of the rotor 26, washers 29 are secured restrictive.

The rotor 9 is inserted into the housing 4, and the gaps between them are filled with grinding bodies 1 of different shapes, sizes and quantities ordered and spontaneous manner. Work surfaces (surfaces that come in contact with the material being ground 3) and the housing 4 and rotor 9 as a cylinder or a cone, a part of them are used as the working and the outer and inner surface thereof. The design of all other parts of this device is similar to a single-layered device structure 7. Single-layer device for grinding 7, realizing the inventive method operates as follows. The ground material fed into the inner rotor 22, the sample 9, due to the centrifugal force generated by rotation of the driven pulley 15, passes through the supply path opening 23 is directed into the gap between the housing 4 and the rotor 9, where it is due to crushing and abrasion sequentially performed disintegration first grinding material 3—big diameter conical rollers 18, more barrel-shaped rollers 19, 20, cylindrical rollers, balls 21 in the vertical cavity and beads 21—in the cavity between the horizontal part of the horizontal body 7 and the horizontal portion of the rotor 12 where the balls 21 orderly move across a path defining the guide grooves 8, which prevents them from falling out of the device by centrifugal force. Under the influence of the same force and crushed material discharge takes place. The rest of the ground material the device 3 moves due to the forces of gravity, the sliding portion of the inner body 4.

For controlling the degree of grinding, the particle shape and performance of the final product size, number and configuration of grinding bodies 1, view them and notches on the working surfaces of the housing 4 and rotor 9 varies widely in respect of compulsory conditions: grinding media 1 must be loaded in a single layer and with a gap between them and the support surface 2, providing efficient transmission of forces from the grinding actuator 24 to comminute.

This gap is one of determining the efficiency of the grinding process parameters, or adjusted or maintained substantially constant, for example by vertical movement along the sliding action of the spline 13 of the adjusting nut 14 of the rotor 9 relative to the housing 4 in the embodiment at least one of their conical shape. In this grinding bodies 1 supported in a standing position on the rotor 9 restrictive washers 29 changes its clearance relative to the housing 4 by the taper.

Fineness of the finished product is subject to change in the number of interactions grinding bodies 1 and milled material 3 by changing the speed of rotation of the actuator 24, changes in the number of milling bodies 1 and the change in the load time of passage of the crushed material in the device by controlling the performance of the original food and the speed of its passage through device.

FIG. 8 shows an embodiment of a multilayer device for crushing, whose performance by grinding in several concentrically arranged unilamellar devices increases considerably. It ground material 3 by analogy with single device pos. 7 sample through the inner flow paths 22 and 23 is supplied to the upper surface of the rotor 9, which is moving through the action of centrifugal force through feed holes 28 due to their inclination counter falls into the grinding zone between concentric parts of the housing 25 and the concentric portions of the rotor 26 under the influence of milling bodies 1, wherein at least move by gravity downward sample material 3, undergoing multiple crushing, abrading and intralayer destruction falls onto the bottom surface of the housing 4 and through the outlet openings 27 discharged as a finished product.

Rotors 9, supported by the adjusting nut 14 to the driven pulley 15 and the rotation support 16 and sliding through the key 13, the rotation of the actuator 27. In the device layers, wherein the outer rotation supporting surface receives two (where the rotor 9 is located outside of the housing 4), pressed to move the rotor 9 by the centrifugal force of the grinding material 3 may be made mandatory, for example, attached to a fixed support surface 2 (case 4) screws or by pumping through devices conveying gas or fluid.

Section of the supply hole 28 from the central unit to the peripheral layers increases proportionally to the diameter of the centers of rotation of the grinding bodies 1 corresponding layer than grinding conditions are identical in each of them. Using, the multilayer embodiment achieves compact high-performance devices, for grinding which by increasing the length, speed and load grinding bodies provide fine, ultrafine and nano powders with high efficiency, high-performance and low (due to low contact time with the support surface 2 and grinding bodies 1) size reduction of impurities.

Using various types of grinding bodies 1, creating different combinations of ordered arrangement of grinding bodies 1 in the guide grooves 8 with spontaneous their placement, you can change the ratio between the crushing and wearing effect on the material to be ground, and adjusting the gap between the grinding bodies 1 and 2 support surfaces can be adjust the degree of impact on the material to be ground 3 intralayer effect grinding in dry and wet. The invention can be used in all industries where it is necessary to obtain powders in the range of size from a few millimeters to the nano size.

1. (canceled)

2. (canceled)

3. (canceled)

4. A method of grinding material comprising;
disintegrating dry and wet grinding material located on grinding surface of rotating bodies having the form of bodies of revolution; and
increasing the grinding efficiency and the efficiency of the process, wherein the grinding media is placed in an orderly and randomly in one layer between the two support surfaces; wherein the gap between the surface of the grinding bodies and the supporting surface is less than 0.86 sets diameter grinding bodies and the supporting surface, which is shaped into a cylinder, a cone or a circle set in parallel or at an angle to each other, the value of which is set smaller than the angle of friction of grinding bodies and supporting surfaces of the material to be ground; while supporting surfaces arranged coaxially relative to each other or to the eccentricity and oriented horizontally, vertically or obliquely.

5. A device for grinding material comprising;
a fixed housing having a closed shape contacting with grinding bodies in the form of bodies of revolution and rotation drive, wherein in order to increase the efficiency and degree of milling body comprises fixedly interconnecting tconical portion and cylindrical step portion and horizontal portion to form a circle, provided with concentric guide grooves; and in the interior of the housing coaxially or eccentrically thereto is placed a rotor consisting of fixedly interconnected by a conical portion and a cylindrical stepped portion having a circular shape, the horizontal portion; the rotor is fixed through a sliding key and the adjusting nut to the driven pulley, through which the rotation support is fixed to a base; and the gaps between the casing and the rotor has grinding bodies having the shape: conical, barrel-shaped or cylindrical rollers or balls of various sizes with surface scored or without it; wherein the inner bottom of the sample top of the rotor, the bore until the loading level of grinding media in its walls drilled starting power supply path, and a driven pulley connected through a belt drive with fixed based actuator.

6. The device as set forth in claim 5 wherein the rotor is made of separate parts concentric cylindrical or conical shape, decreasing from the periphery towards the center diameter which are arranged between the grinding bodies; wherein for each row of grinding bodies in the body are drilled discharge openings, and all parts of the rotor in the lower part and the washer are restrictive on each row of grinding bodies at an angle from the center to the periphery drilled feed hole; wherein some of the parts of the housing and the rotor into contact with grinding media from both sides.
